(19) United States
(12) Patent Application Publication
(10) Pub. No.: US 2024/0106302 A1
(43) Pub. Date: Mar. 28, 2024

(54) SUPERCONDUCTING MOTOR STATOR, AIRCRAFT SUPERCONDUCTING MOTOR, AND AIRCRAFT

(71) Applicant: Airbus SAS, BLAGNAC (FR)

(72) Inventors: Alexandre COLLE, BLAGNAC (FR); Reda ABDOUH, BLAGNAC (FR); Robin CURELLI, BLAGNAC (FR)

(21) Appl. No.: 18/470,627

(22) Filed: Sep. 20, 2023

(30) Foreign Application Priority Data
Sep. 22, 2022 (FR) 2209588

(51) Int. Cl. H02K 9/19; B64D 33/08; H02K 55/02

(52) U.S. Cl. CPC H02K 9/19; B64D 33/08; H02K 55/02

(57) ABSTRACT

A superconducting motor stator comprising a cryogenic cooler in the form of a ring inside which are arranged superconducting windings each positioned on a hybrid structure formed from a stack of at least iron elements and of elements made of a material with high thermal conductivity such as special ceramic, for example sapphire, copper, diamond or aluminum.

### CROSS-REFERENCES TO RELATED APPLICATIONS

This application claims the benefit of French Patent Application Number 2209588 filed on Sep. 22, 2022, the entire disclosure of which is incorporated herein by way of reference.

### FIELD OF THE INVENTION

The present invention relates to a so-called superconducting motor, in particular of the type which can be used for the propulsion of an aircraft. The invention relates more particularly to an aircraft motor stator comprising a cryogenic cooling assembly, to a superconducting motor comprising such a stator, and to an aircraft.

### BACKGROUND OF THE INVENTION

Motors referred to as “superconducting motors” comprise a plurality of windings of ribbons made from a superconducting material and cooled at cryogenic temperatures. Usually, each of the windings of such a motor is provided with its own cryogenic cooling system and all the systems for cooling windings are connected to one another so as to be supplied from a common cryogenic fluid source. The cooling systems are implemented as close as possible to the superconducting windings, which can be directly welded to the cooling systems, or else be immersed in a cryogenic fluid circulation circuit. Although such configurations allow easy extraction of the heat generated in and by the windings, they prove, however, to be bulky, heavy and sometimes even difficult to industrialize. In addition, such configurations lead to temperature gradients within the windings.

The situation can be improved.

### SUMMARY OF THE INVENTION

An object of the present invention is to propose a superconducting motor comprising a lighter and less bulky cooling system so as to increase the performance of an aircraft in which such a motor is installed, and in particular the ratio between its weight and the electrical power used on-board the aircraft.

Accordingly, what is proposed is a superconducting motor stator comprising a cooling element referred to as a “cryogenic cooler” configured to circulate a cryogenic fluid therein, and a plurality of superconducting windings each forming an electromagnetic pole of said stator, said stator being configured such that:
said cryogenic cooler has an overall ring shape comprising an inner wall along the inside diameter of said ring,
one or more hybrid magnetic structures are arranged in contact with said inner wall, and
each of said superconducting windings is arranged on a hybrid magnetic structure, on the opposite side of said hybrid magnetic structure with respect to said inner wall, such that the hybrid magnetic structure or structures carry out a transfer of heat between said superconducting windings and said inner wall.

According to the invention, the hybrid magnetic structure or structures comprise a stack of at least first elements made from a first magnetically conducting material, and of second elements made from a second thermally conducting and electrically conducting or insulating material, the stack being such that the two ends of each of said elements are respectively in contact with said inner wall and with one of said superconducting windings.

The superconducting motor stator according to the invention may further comprise the following features, considered alone or in combination:
the first material is iron and the second material is special ceramic, for example sapphire, copper, diamond or aluminum;
said stack further comprises at least one insert element arranged between one of the first elements and one of the second elements, or between two of the first elements, or else between two of the second elements;
the stack of the first elements and of the second elements is regular;
the stack of the first elements and of the second elements is irregular; and,
the stack comprises between 70 and 80% of first elements and between 20 and 30% of the second elements.

The invention also relates to a superconducting motor comprising a superconducting stator as described above.

Finally, the invention relates to an aircraft comprising at least one superconducting motor as mentioned above.

### BRIEF DESCRIPTION OF THE DRAWINGS

The features of the invention mentioned above along with others will become more clearly apparent on reading the following description of an exemplary embodiment, said description being given with reference to the appended drawings:

FIG. 1 schematically illustrates a superconducting motor stator according to one embodiment;

FIG. 2 illustrates details of implementing a hybrid magnetic structure of the stator already shown in FIG. 1; and

FIG. 3 illustrates an aircraft comprising a superconducting stator according to one embodiment.

### DETAILED DESCRIPTION OF THE PREFERRED EMBODIMENTS

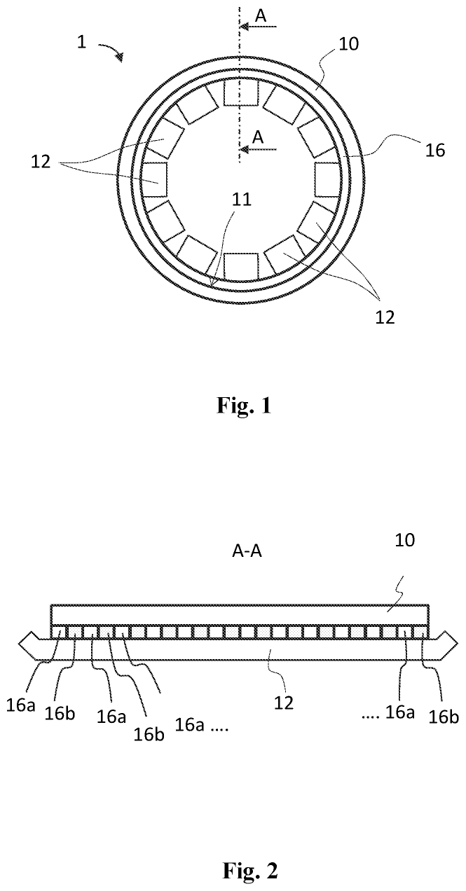

FIG. 1 is a schematic representation of a superconducting motor stator 1. The term “superconducting motor” here denotes an electric motor comprising at least one element produced from a superconducting material and in particular for implementing a function of inducing an electromagnetic field. According to one embodiment, the superconducting motor comprising the stator 1 is a motor for propelling an electrically propelled aircraft. The stator 1 performs the role of an inductor in the motor which comprises it, by virtue of a plurality of superconducting windings 12. Each of the superconducting windings 12 comprises at least one ribbon (i.e. a strip) of superconducting material wound on itself. The superconducting windings 12 are connected to a current source module (not shown as not necessary for good understanding of the invention). The stator 1 comprises a cooling element 10, also referred to as a “cryogenic cooler”, configured to circulate therein a cryogenic fluid such as, by way of example, liquid hydrogen pumped from a liquid hydrogen reservoir on-board an aircraft. The cryogenic cooler 10 comprises for this purpose a cryogenic cooler inlet and a cryogenic cooler outlet. The cryogenic cooler 10 also comprises an internal arrangement allowing homogenous circulation of a cryogenic fluid within itself, between its input and its output, so as to ensure good temperature homogeneity in its body. For example, the cryogenic cooler 10 comprises a winding of a cryogenic line forming rings within a solid body having an overall annular shape with a surface interior to the ring and a surface exterior to the ring. According to one embodiment, the assembly of the stator 1 is moreover housed within a cryostat.

Advantageously, the cryogenic cooler 10 is therefore arranged so as to have an overall ring shape in which are arranged the superconducting windings 12 jointly performing the function of an inductor of the motor which comprises the stator 1.

Advantageously and according to one embodiment, the cryogenic cooler 10 having an annular shape comprises an inner surface 11 along the inside diameter of the ring formed by the overall shape of the cryogenic cooler 10. In other words, the inner surface 11 has an arrangement along the inside diameter of the ring formed, by opposition to an outer surface, which is arranged along the outside diameter of the ring formed. In other words still, each of the points of the inner surface 11 of the cryogenic cooler 10 has, for tangent, a radius of a circle formed by the inner surface 11.

Ingeniously, the stator 1 comprises, arranged between the cryogenic cooler 10 and the various superconducting windings 12, one or more hybrid magnetic structures 16 arranged both in contact with the cryogenic cooler 10 and with one or more superconducting windings 12. Preferably, the stator 1 comprises a single hybrid magnetic structure 16 for all the superconducting windings 12. A partial section A-A of the stator 1 of FIG. 1 forms FIG. 2, which illustrates details of implementing the hybrid magnetic structure 16 or the hybrid magnetic structures 16, where appropriate. According to one embodiment, the magnetic structure 16 is a stack of first elements 16a and of second elements 16b forming a single hybrid magnetic structure, also of overall annular shape for its part, concentric with the cryogenic cooler 10 and also concentric with the ring of superconducting windings 12 formed by the latter regularly arranged within the ring formed by the cryogenic cooler 10. According to one variant, each of the superconducting windings 12 is arranged on its own hybrid magnetic structure 16, independent of the hybrid magnetic structure of an adjacent superconducting winding 12 in the ring of superconducting elements 12 formed by all the superconducting elements 12 together. This configuration makes it possible to lighten the weight of the stator when mutually adjacent superconducting windings 12 are relatively distant.

FIG. 2 details the stack comprising at least the first elements 16a and the second elements 16b, arranged to form an alternation (a stack) between the two types of elements, the stack extending along an axis parallel to the longitudinal axis of the stator 1. The alternation between the first elements 16a and the second elements 16b can be regular. Preferably, the alternation between the first elements 16a and the second elements 16b is irregular. According to a preferred embodiment, the first elements 16a are made of iron and the second elements 16b are made of special ceramic, for example sapphire or copper, or diamond or else aluminum. These examples are not limited, and other materials may be used as long as the material used for the first elements is a good magnetic and electrical conductor and the material used for the second elements is a good thermal conductor. For example, the stack may comprise between 70 and 80% of first elements 16a, and between 20 and 30% of second elements 16b. Thus, it is advantageously possible to attain an optimized ratio between the cooling capacity of the superconducting windings 12 and the weight of the stator 1, which is particularly advantageous in the case of an aircraft superconducting motor. According to various embodiments, the hybrid magnetic structure or structure 16 may comprise insert (or spacer) elements arranged between elements as mentioned above, in particular for the purpose of reducing the production costs of the hybrid magnetic structure or structures without, however, consequently reducing the efficiency of such a hybrid structure. It is thus possible to benefit from a low temperature gradient between the cryogenic cooler 10 and the superconducting windings 12 of the stator 1, which corresponds to improved cooling of the latter on account of them being kept at a very low temperature.

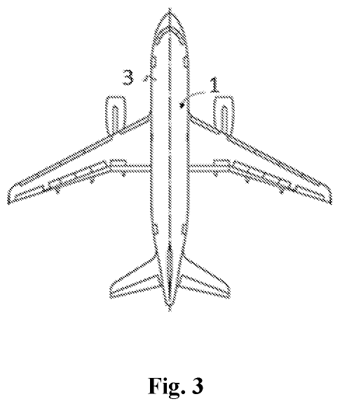

FIG. 3 shows an aircraft 3 advantageously comprising a superconducting motor provided with a stator similar to the stator 1 described above, which makes it possible to obtain a very high power density for the system for propelling the aircraft and of thus increasing its flight performance.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A superconducting motor stator comprising:
a cooling element, referred to as a cryogenic cooler, configured to circulate a cryogenic fluid therein, and
a plurality of superconducting windings each forming an electromagnetic pole of said stator,
wherein said cryogenic cooler has a ring shape comprising an inner wall along an inside diameter of said ring shape,
wherein one or more hybrid magnetic structures are arranged in contact with said inner wall, the one or more hybrid magnetic structures comprising a stack of first elements made from a first, magnetically conducting, material and of second elements made of a second, thermally conducting, material, the stack being such that ends of each of said first and second elements are respectively in contact with said inner wall and with one of said superconducting windings, and,
wherein each of said superconducting windings is arranged on a hybrid magnetic structure, on an opposite side of said hybrid magnetic structure with respect to said inner wall, such that the one or more hybrid magnetic structures carry out a transfer of heat between said superconducting windings and said inner wall.

2. The superconducting motor stator according to claim 1, wherein the first material comprises iron and wherein the second material comprises sapphire, copper, diamond or aluminum.

3. The superconducting motor stator according to claim 1, wherein said stack further comprises at least one insert element arranged between one of said first elements and one of said second elements, or between two of said first elements, or between two of said second elements.

4. The superconducting motor stator according to claim 1, wherein the stack of the first elements and the second elements is regular.

5. The superconducting motor stator according to claim 1, wherein the stack of the first elements and the second elements is irregular.

6. The superconducting motor stator according to claim 1, wherein the stack comprises between 70% and 80% of first elements and between 20% and 30% of the second elements.

7. A superconducting motor comprising:
the superconducting motor stator according to claim 1.

8. An aircraft comprising:
at least one superconducting motor according to claim 7.
